(19) United States
(12) Patent Application Publication
(10) Pub. No.: US 2004/0253152 A1
(43) Pub. Date: Dec. 16, 2004

(54) Equipment for reconstructing environment of forest with germicide, disinfecting and deodorizing functions

(76) Inventor: Che-Peng Liang, Fongshan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/457,417

(22) Filed: Jun. 10, 2003

(51) Int. Cl. B32B 5/02; A62B 7/08

(52) U.S. Cl. 422/120; 422/121; 422/123

(57) ABSTRACT

An equipment for reconstructing environment of forest includes a phytonicidene container having phytonicidene contained therein, a booster, a high-energy molecule dividing device connected to the booster, and a generator of negative charges connected to the booster; the high-energy molecule dividing device and the generator of negative charges are made to generate a large amount of high-energy ionized small molecules, including ozone, and anions, by means of boosting of the booster, which high-energy ionized small molecules will get rid of the organic poisonous substance, germs, toxicants, and unpleasant odor in the air, making air in the environment like that in forests.

### BACKGROUND OF THE INVENTION

1. Field of the Invention

The present invention relates to an equipment for reconstructing environment of forest with germicide, disinfecting and deodorizing functions, more particularly one, which is suitable for use in virtually closed rooms such as hospitals, houses, and building for various activities, and which consists of phytonicidene container, high-energy molecule dividing devices, generators of negative charges, high-efficiency filters, and electric fans so as to be capable of decomposing, and oxidizing and reducing air in the environment as well as sterilizing, getting rid of toxic substance, and deodorizing.

2. Brief Description of the Prior Art

Living environment of human has been changing remarkably with multiplication of population and change of the way human is involved in economic activities in recent decades, from a state where there was much room for each person, enough natural ventilation, and the use of natural materials for almost all things in living, and less close contact between people to a state where there are many air-conditioned and crowded high buildings, the use of synthetic materials for almost all things in living, and constant close contact between people. The use of natural materials can prevent germ from growing to some degree. And, spreading of infectious diseases from one district to others was limited because villages where people resided were usually spaced far apart in ancient time.

In modern world, cities are densely populated, in which there are frequent face-to-face communications between people dealing with various matters, and most public buildings are air-conditioned with central air conditioning systems, and people can travel from one big city to another in few hours or even only a few minutes with modern transportation. Consequently, bacteria invade, and spread between people easily. Furthermore, because hospitals are also air-conditioned with central air conditioning systems, infectious diseases are prone to spread from the patients to other well people such as the medical personnel, and those who visit the sick. The followings are some of the major causes of wide and fast spreading of infectious diseases in modern time:

1. Centralization of population, frequent close contact between people, and the use of public transportation such as trains, and airplanes, which allows people to travel over a large area within short time;

2. Lack of natural ventilation: windows of public places, e.g. shopping malls, hospitals, and public transportations, are closed because the use of central air conditioning systems, and in turns, there is no enough natural ventilation in the public buildings.

3. Lack of healthful way of life: residents of cities are relatively busy, and don't have many opportunities to do exercise or contact with healthful environments such as mountains and forests, therefore their immune systems become weak, and in turns, germs can invade easily.

4. Abuse of medicine and drug: abuse of medicine and drug has affected the whole ecosystem badly, and resulted in resistance of bacteria to the action of drugs, and in turns, human are more likely to be invaded and harmed by bacteria.

5. Mistakes in service of hospitals: hospitals are provided with isolated rooms for preventing certain infectious diseases that can spread easily from spreading to other areas, but some kinds of mistakes of the medical personnel can lead to serious infection among people inside the hospital, e.g. the medical personnel themselves and those who visit the sick, causing the diseases to spread outside the hospitals.

Furthermore, much waster will be produced in our daily living, which will cause unpleasant odors difficult to get rid of. Conventional ways of reducing such unpleasant odors include improvement on ventilation, frequent cleaning, using deodorants, and fragrance. However, some places used for particular purposes have to have their windows closed, and there is limited ventilation in such places. And, the smell of conventional fragrances is not only incapable of effectively making unpleasant odors disappear but also prone to make some people feel uncomfortable.

People can feel comfortable and pleasant in forests because forests are environments capable of providing fresh and pleasant-smelling air. As a matter of fact, forests are environments where air is filtered and cleaned, and germs and bad odors of organic toxicants are decomposed, and eliminated, and where there are a large of amount of essence and many anions capable of freshening the air, and there are natural high-energy molecules capable of neutralizing and eliminating germs, organic toxicants, and bad odors, including those produced by dead bodies of creatures and plants. People, especially those living in city jungles, need to spend as long time as possible staying in environments like forests for the benefit of the health, which unfortunately are not provided by modern air-conditioning systems.

### SUMMARY OF THE INVENTION

It is a main object of the present invention to provide an equipment for reconstructing environment of forest with germicide, disinfecting and deodorizing functions, which is suitable for use in virtually closed rooms.

The present equipment includes a phytonicidene container having phytonicidene contained therein, a booster, a high-energy molecule dividing device connected to the booster, and a generator of negative charges connected to the booster; the high-energy molecule dividing device and the generator of negative charges are made to generate a large amount of high-energy ionized small molecules, including ozone, and anions, by means of boosting of the booster, which high-energy ionized small molecules will oxidize and reduce organic poisonous substance, unsaturated and unstable molecules in air, to get rid of the organic poisonous substance and unpleasant odor, and will cooperate with phytonicidene from the phytonicidene container to eliminate germs, and unpleasant odor in the air; thus, air in the environment is made to be fresh and pleasant-smelling like that in forests.

### BRIEF DESCRIPTION OF THE DRAWINGS

The present invention will be better understood by referring to the accompanying drawings, wherein:

FIG. 1 is a block diagram of the equipment for reconstructing environment of forest with germicide, disinfecting and deodorizing functions according to the present invention,

FIG. 2 is an exploded perspective view of the equipment for reconstructing environment of forest according to the present invention,

FIG. 3 is a view of inside of the equipment for reconstructing environment of forest according to the present invention, and

FIG. 4 is a side view of inside of the equipment for reconstructing environment of forest according to the present invention.

### DETAILED DESCRIPTION OF THE PREFERRED EMBODIMENTS

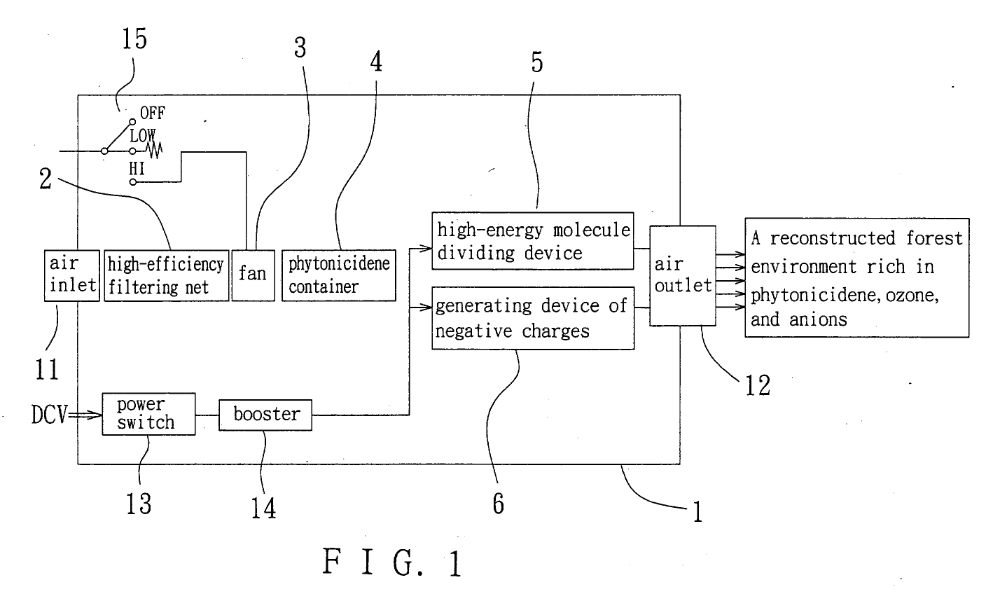

Referring to FIG. 1, a preferred embodiment of an equipment for reconstructing environment of forest with germicide, disinfecting and deodorizing functions in the present invention includes a housing, a high-efficiency filtering net 2, an electric fan 3, a phytonicidene container 4, a high-energy molecule dividing device 5, a generating device of negative charges 6, a power switch 13, a booster 14, and a fan controlling switch 15.

The housing is formed with an inlet, and two outlets for allowing air to travel through.

The high-efficiency filtering net 2 is disposed over the inlet of the housing for stopping harmful particulates, dust, germs, and poisonous substance in the air from traveling into the housing.

The fan 3 is disposed in the housing for forcing air outside the housing to pass through the housing from the high-efficiency filtering net 2 to the outlets. The speed of the fan 3 is controllable with the switch 15.

The phytonicidene container 4 is disposed in the housing, and is filled with phytonicidene. The high-energy molecule dividing device 5 is disposed in the housing, and electrically connected to the booster 14 so that it can be made to generate high-energy ionized small molecules, and ions, including ozone with boosting of the booster 14, which high-energy ionized small molecules, and ions, including ozone, will combine with air passing through the housing to oxidize and reduce organic poisonous substance, produce oxygen, and get rid of organic poisonous substance and unpleasant odor; thus, proportion of oxygen in the air can increase.

The generating device of negative charges 6 is disposed in the housing, and electrically connected to the booster 14 so as to be made to generate high concentration of anions (negative ions) with boosting of the booster 14.

To use the present equipment, the power switch 13 is moved so as to turn on both the electric fan 3 and the booster 14; thus, the high-energy molecule dividing device 5, and the generating device of negative charges 6 work to generate high-energy ionized small molecules, and ions, including ozone and high concentration of anions, and air outside the housing is made to pass from the high-efficiency filtering net 2 to the outlets, and pass over the essence container 4, the high-energy molecule dividing device 5, and the generating device of negative charges 6, coming contact with essence from the container 4, the high-energy ionized small molecules, and the ions. Consequently, air passing out of the housing is free of harmful particulates, dust, germs, and poisonous substance, and has contained in it a large amount of essence, high concentration of high-energy ionized small molecules, and ions, including ozone and high concentration of anions, by means of which most of the unpleasant odor, germs, and organic poisonous substance in the air are gotten rid of, and is made fresh and pleasant-smelling like that in the environments of forests by means of essence, oxygen, and anions.

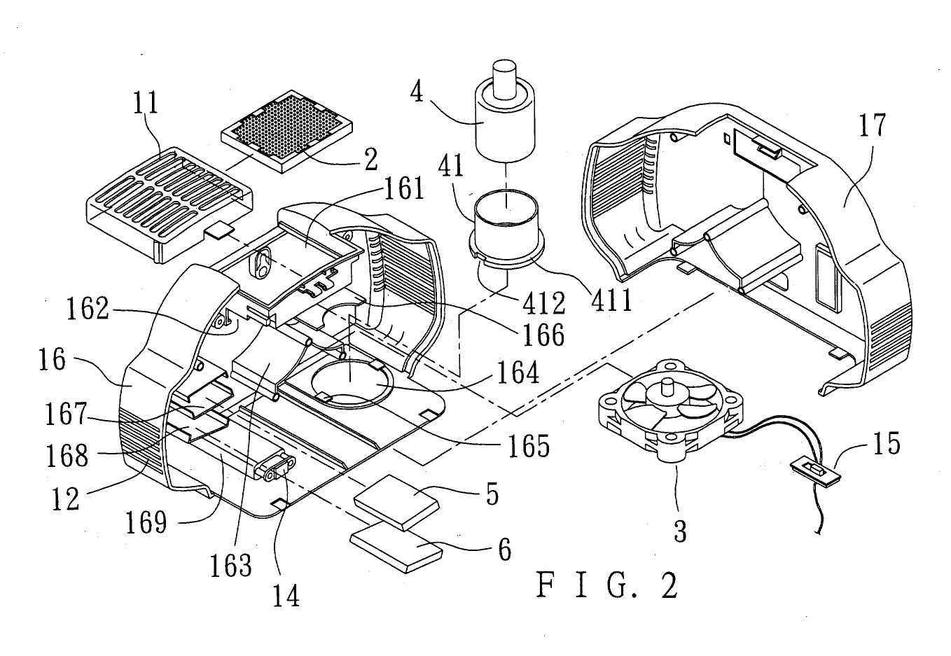

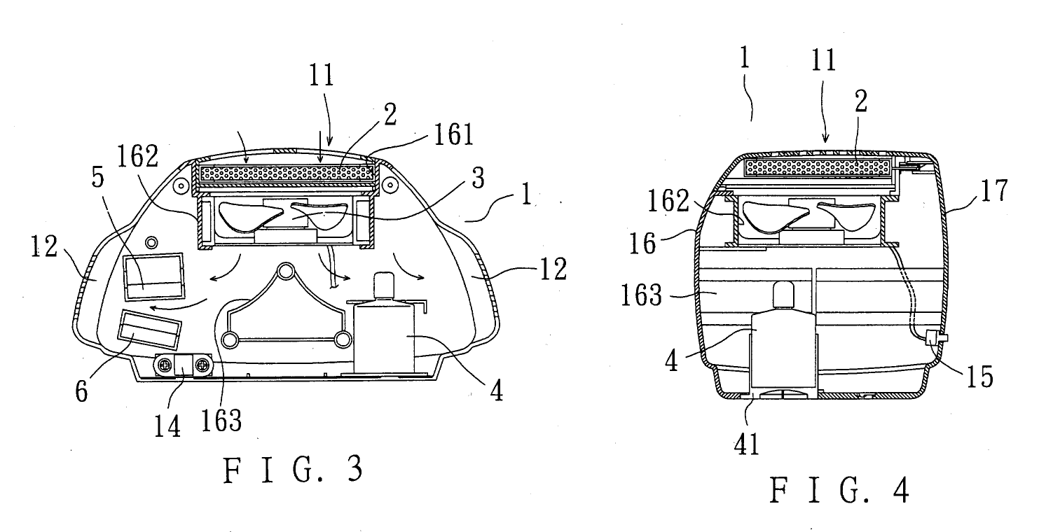

More specifically, referring to FIGS. 2 to 4, the housing consists of front and rear parts 16, 17, and is formed with an opening 161 on the top. Left and right air outlets 12 are provided on two opposing lateral sides of the housing. An air inlet 11 is disposed over the opening 161 of the housing, and high-efficiency filtering net 2 is disposed under the air inlet 11. An insertion trench 162 is formed under the opening 161, and electric fan 3 is fitted to the insertion trench 162. Left and right sloping guiding plates 163 are provided under the fan 3 in the housing, which are positioned in such a manner as to be higher at inner ends, and lower at outward ends to be directed towards corresponding ones of the lateral outlets 12, 12; thus, air from the fan 3 can be guided to the left and right outlets 12, 12. High-energy molecule dividing device 5, and generating device of negative charges 6 are disposed between the left outlet 12 and the left sloping guiding plate 163 while essence container 4 is disposed between the right outlet 12 and the right sloping guiding plate 163.

Furthermore, referring to FIG. 2, an insertion hole 164 is formed on a bottom of the housing, and a securing plate 166 is provided above the insertion hole 164. Two detaining protrusions 165 are formed on the upper end portion of the edge of the insertion hole 164. A second holding base 41, which is formed with a bottom annular protrusion 411, and gaps 412 on the bottom annular protrusion 411, is provided for the phytonicidene container 4; the phytonicidene container 4 is fitted in the holding base 41 while the holding base 41 is securely fitted to the insertion hole 164 at the bottom annular protrusion 411 thereof; in joining the holding base 41 to the insertion hole 164, the gaps 412 of the holding base 41 are first faced with respective ones of the detaining protrusions 165 for allowing the bottom annular protrusion 411 to be passed into the insertion hole 164, and the holding base 41 is turned after the bottom annular protrusion 411 has been passed into the insertion hole 164 so that the holding base 41 is securely disposed in the housing; the securing plate 166 will contact the top of the phytonicidene container 4 after the phytonicidene container 4 is fitted in position so that the container 4 won't be shaky.

And, plates are disposed in the housing to form upper and lower holding rooms 167, 168 for holding the high-energy molecule dividing device 5, and the generating device of negative charges 6 in position respectively, as shown in FIG. 2. And, a holding base 169 is provided under the holding rooms 167, 168 for holding booster 14 in position.

The equipment for reconstructing environment of forest is relatively compact, portable, and convenient to use, and can be disposed adjacent to air vents of an automobile for use inside the automobile, and can be disposed in rooms or other vehicles such as railway carriages, and containers. Thus, having been first filtered to be free of harmful particulates, dust, germs, and poisonous substance by means of the filtering net 2, air passing out of the housing is relatively clean. And, air passing out of the housing contains a large amount of high concentration of phytonicidene, high-energy ionized small molecules, and ions, including ozone and high concentration of anions, by means of which the unpleasant odor, germs, and organic poisonous substance in the air are virtually eliminated, and is made fresh and pleasant-smelling like that in the environments of forests by means of essence, oxygen, and anions. In other words, the present equipment has germicide, disinfecting and deodorizing functions. And, oxidation and reduction are made to happen, and molecules are made to be saturated and in a stable state by means of the high concentration of high-energy unsaturated molecules, which can easily combine with germs, and organic poisonous substance in the air, as well as the high-energy ions, by which the environment is made to be in a state having high-energy anions.

A performance test of the present equipment was done by SGS Taiwan Ltd., and the followings are reported according to the test:

Date of sample received: Nov. 27, 2002

Date of testing: Nov. 28, 2002

Test requested & method:

Reference: U.S. Pharmacopeia 24 NF 19 Microbiological Tests (51) Antimicrobial Effectiveness Testing. Location of sampling/testing: Laninar Flow (Size: Long×Wide×High=121 cm×66.7 cm×57 cm) Sampling method:

1. Cover the outlet of the active carbon filter by filter which has been inoculated a specific bacteria.

2. Turn on the machine for 30 and 60 minutes.

3. Sample should be collected from the filter then test the specimen and count.

Test Result:

| Test Item | 0 min | 30 min | 60 min |
|---|---|---|---|
| Totasl plate count (CFU/ml) | 9.6 × 10⁵ | 6.2 × 10⁵ | 3.7 × 10³ |
| Staphylococcus aureus (CFU/ml) | 5.5 × 10⁵ | 4.6 × 10⁵ | 7.8 × 10² |
| Escherichia coli (CFU/ml) | 1.3 × 10⁵ | 1.1 × 10⁵ | not detected |
| Pseudomonas aeruginosa (CFU/ | 2.7 × 10⁵ | 3.1 × 10⁴ | not detected |
| ml) | | | |

From the above test result, it can be understood that total plate count, 9.6×10⁵ at the beginning, reduces to 6.2×10⁵ thirty minutes after use of the equipment, and 3.7×10³ sixty minutes after use of the equipment; Staphylococcus aureus, 5.5×10⁵ at the beginning, reduces to 4.6×10⁵ thirty minutes after use of the equipment, and 7.8×10² sixty minutes after use of the equipment; Escherichia coli, 1.3×10⁵ at the beginning, reduces to 1.1×10⁵ thirty minutes after use of the equipment, and 0 sixty minutes (not existing) after use of the equipment; Pseudomonas aeruginosa, 2.7×10⁵ at the beginning, reduces to 3.1×10⁴ thirty minutes after use of the equipment, and 0 sixty minutes after use of the equipment (not existing).

Respiratory infection is the major infection, and urinary tract infection the second one in ordinary hospital wards and intensive care units. Respiratory infection is the most in intensive care units. Respiratory infection and blood circulation infection are the most in ordinary hospital wards. Pollution of the environment and respirators can be blamed for most respiratory infection while blood vessel ductus infection for blood circulation infection; medical personnel's hands can be the ways of infection. Gram-negative bacteria are the most infectious bacteria, the proportion of which is 62.2%, gram-positive bacteria the second most, the proportion of which is 21.9%, mold fungi the third most, the proportion of which is 11.8%, and other bacteria 3.6%. Monoclonal pathogenic bacteria are the most, the proportion of which is 69.7%, polyclonal pathogenic bacteria are the second most, the proportion of which is 27.0%, and others 3.3%. Pseudomonas aeruginosa cause the most (11.9%) infections in hospitals, fungi the second most (11.8%), Staphylococcus aureus the third most (7.9%). And, Methicillin-resistant Staphylococcus Aureus (MRSA), fungi, and Acinetobacter spp. are found to have an increasing tendency.

Wherein the proportions of Pseudomonas aeruginosa, Staphylococcus aureus, and Escherichia coli respectively are 11.9%, 9.7%, and 9.4%, amounting to a large portion. Therefore, it can be seen that the equipment of the present invention can reduce and kill germs in the air effectively. And, the equipment can also get rid of toxicants.

From the above description, it can be easily understood that the forest environment reconstruction equipment of the present invention can eliminate toxicants, unpleasant odors as well as germs to make air fresh and pleasant-smelling like that in the environments of forests, thus reducing and restraining the spreading of germs, and bacteria by means of contact transmission, droplet transmission, and airborne transmission, and making virus inactive.

The equipment for reconstructing environment of forest can first filter air to make the air cleaner, and then make the air full of healthful substance such as high concentration of phytonicidene, high-energy ionized small molecules, and ions, including ozone and high concentration of anions; thus, unpleasant odor, germs, and organic poisonous substance in the air are virtually eliminated, and is made fresh and pleasant-smelling like that in the environments of forests. Bacteria and virus, including those floating in the air, and those on the infected body parts of patients, won't be viable under such environment rich in high concentration of essence, high-energy ionized small molecules, and ions, including ozone and anions.

Equipments of the present invention can be positioned over all vents of central air conditioning system of hospitals such that germs, organic poisonous substance, bacteria, and virus can be significantly reduced, preventing diseases from spreading within and outside hospitals, and protecting the medical personnel against various infectious diseases.

Therefore, the forest environment reconstruction equipment of the present invention, though small in size, is convenient to use and capable of effectively eliminating germs, toxicants, and unpleasant odors to provide people with fresh, healthful, and pleasant-smelling surrounding air.

What is claimed is:

1. An equipment for reconstructing environment of forest with germicide, disinfecting and deodorizing functions, comprising
a phytonicidene container having phytonicidene contained therein;
a booster;
a high-energy molecule dividing device electrically connected to the booster; and
a device for generating negative charges electrically connected to the booster;
the high-energy molecule dividing device and the device for generating negative charges being provided for generating a large amount of high-energy ionized small molecules, including ozone, and anions, by means of boosting of the booster, which high-energy ionized small molecules will combine with unsaturated molecules of organic poisonous substance in air to get rid of the organic poisonous substance, making air in environment have high-energy ions contained therein, and will cooperate with phytonicidene floating out of the essence container to get rid of germs, toxicants, and unpleasant odor in the air.

2. An equipment for reconstructing environment of forest with germicide, disinfecting and deodorizing functions, comprising
a housing formed with an inlet, and a plurality of outlets for allowing air to travel through;
a fan disposed adjacent to the inlet of the housing for forcing air outside the housing to pass through the housing;
a phytonicidene container disposed near to the fan in the housing; the phytonicidene container having phytonicidene contained therein;
a booster;
a high-energy molecule dividing device disposed near to the fan in the housing, and electrically connected to the booster; and
a device for generating negative charges disposed near to the fan in the housing, and electrically connected to the booster;
the high-energy molecule dividing device decomposing molecules of phytonicidene of the container by means of boosting of the booster; the high-energy molecule dividing device and the device for generating negative charges generating a large amount of high-energy ionized small molecules, including ozone, high concentration of anions, and high-energy unsaturated molecules capable of easily combining with germs, and organic poisonous substance in air, by means of boosting of the booster, and which high-energy ionized small molecules will combine with organic poisonous substance in air to get rid of the organic poisonous substance, making air in environment have high-energy ions and phytonicidene contained therein, and getting rid of germs, toxicants, and unpleasant odor in air, which is then forced to travel outside through the outlets of the housing.

3. The equipment for reconstructing environment of forest with germicide, disinfecting and deodorizing functions as claimed in claim 2, wherein a filtering net is disposed over the inlet of the housing.
